(19) United States
(12) Patent Application Publication
(10) Pub. No.: US 2011/0073012 A1
(43) Pub. Date: Mar. 31, 2011

(54) Kaolin processing

(76) Inventor: Wayne M. Bundy, Tesuque, NM (US)

(21) Appl. No.: 12/586,987

(22) Filed: Sep. 29, 2009

(51) Int. Cl. C09C 1/36

(52) U.S. Cl. 106/446

(57) ABSTRACT

The embodiment of kaolin quality improvement includes a chemical, heating method for processing kaolin to high brightness levels and lower viscosities. This permits addition of natural titania for greater opacity in commercial paper coating. Mechanism of brightness improvement includes removal of iron oxides and iron sequestered by natural organic acids. Viscosity is improved by removal of organic and at least partial decomposition of expandable clay, such as montmorillonite.

Kaolin crude is dispersed preferably with Calgon at minimum level. Classification to desired particle size is followed by adding 0.2 percent sodium sulfate decahydrate. After raising pH to 8.5 with dilute sodium hydroxide the slip is heated to 65 to 70 degrees centigrade for 5 to 60 minutes. Cooled to at least 40 degrees centigrade, the slip is bleached with sodium hydrosulfite. Time of bleach is 20 minutes at pH 3 to 3.5. Efficient filtration and rinsing is critical, a 2:1 ratio of water to dry clay rinse preferable.

### BACKGROUND OF THE INVENTION

1. Field of the Invention

The embodiment of my application increases brightness and lowers viscosity of kaolin and blends of kaolin with titanium mineral rejects relative to standard processing.

2. Description of Related Art

Standard industry practice is to improve kaolin brightness by bleaching with sodium hydrosulfite. This reduces ferric to ferrous iron for acid solubility and removal by filtration and rinsing. Brightness and viscosity are critical properties of kaolin in the paper industry. Paper coaters, in particular, demand kaolin having high brightness and low viscosity. Those special kaolins producing high opacity and gloss in coatings are highly valued as well.

Huge tonnages of kaolin are used worldwide in papermaking. Kaolin markets are growing with population growth and third-world economic development. Many world kaolin deposits are sufficient in quantity but not in quality. Brightness and viscosity improvement of these deposits would allow their economic development.

Titania extraction from kaolins supplements methods for brightness improvement in special products. But titania minerals' high refractive indices are invaluable for imparting opacity to films. Low brightness precludes industry adding natural titania minerals to kaolin for opacity improvement. An additional method of brightness improvement is by oxidation. Kaolin with insoluble organic complexed with ferrous iron are oxidized. Oxidation is best carried out by ozonation. This eases iron removal for brightness improvement.

U.S. Pat. No. 5,128,027 describes a method to improve kaolin viscosity and brightness. The method removes mineral slimes. This is accomplished by dispersion with peptizing agents, such as Calgon, sodium hexametaphosphate. Amount used ranges from 0.35 percent to 1 percent on dry kaolin weight. The product is treated with 0.05% of an oxidizing agent as well. Centrifugation removes particles having a particle size less than 0.2 microns.

U.S. Pat. No. 6,312,511 teaches blending of different kaolins to achieve high brightness and opacity potential in applications.

Rod Phelps, 1963, removes organic from ball clays that are comprised largely of kaolin. He disperses organic with alkali, preferably sodium hydroxide. A pH of 10 is required to totally remove organic from particle surfaces. Polyphosphates and polysilicate dispersing agents aid organic dispersion as well.

### DETAILED DESCRIPTION

The present embodiment improves kaolin brightness and brightness of natural titania blends with kaolin. Invaluable opacifying products are at hand. Especially in lightweight publication paper coating, low viscosity and high brightness are demanded. Opacity enhancement of coatings by kaolin is highly valued, but it is rarely available in consistent form.

Opacity improvement in films can be derived from kaolins by three mechanisms: 1 particle packing allowing air-filled voids to affect enhanced light scatter; 2 reduced calendaring to achieve high gloss. Thus the coating is not compacted to eliminate air-filled voids; 3 increased light scatter affected by large differences in refractive indices of components. The latter method is most reliable and relates to the present application.

World kaolin deposits usually contain the titania minerals, anatase and rutile. Titania generally is present in Georgia paper grade kaolins near 1.5 weight percent. These mineral polymorphs have the composition TiO₂ but have different crystal structure. Natural titania's low brightness is a great disadvantage for use in papermaking. Low percentage occurrence in kaolin reflects its notable power for decreasing kaolin brightness. Structural iron in titania is the usual explanation for low brightness. Adsorbed iron, as oxides and organic complexes cause brightness degradation as well. Removal of these impurities from surfaces, especially titania enables more efficient iron extraction. By this, even without titania extraction from kaolin, signifi9cantly higher brightness than with standard processing results.

High refractive indices of titania minerals and their impurities efficiently scatter non-white light. Reddish brown, tan, to yellowish coloration are imparted by the titania complex. Approximate average refractive indices of titania minerals are much higher than for kaolin:
Kaolin, 1.56
Anatase, 2.5
Rutile, 2.75
Brookite, 2.6

Large differences in refractive indices between kaolin and titania create significant light scatter. Color Intensification of titania-iron complex results. Pure, bright, synthetic titania is used in papermaking to improve brightness and opacity. Opacity of paper coating precludes excessive show-through of printing on opposite side of paper. Only small additions are necessary, up to about 5 percent. Opacity development by increased reflection or light scatter is illustrated by the equation:

Reflection coefficient, R=(n₁−n₀)²/(n₁+n₀)²
n₁, refractive index of particulates
n₀, refractive index of medium, in this case adhesive and air-filled voids

Adhesives are organics having low refractive indices. Minute air-filled-voids, are the lowest in refractive index. They notably enhance brightness and opacity. Other potential applications are paper filling, paint films, and plastics.

Natural titania additions to kaolin become practical in the present embodiment. Brightness of these blends is increased up to acceptable product levels. Natural titania can be derived from titania extraction processes used increase kaolin brightness. Flotation, wet magnetic separation, and selective flocculation comprise titania extraction methods by kaolin industry.

### DETAILED DESCRIPTION

Natural titania in kaolin largely have optimum particle diameter, 0.2 to 0.3 microns for light scatter. Brightness of 87 to 90 for natural titania blends with kaolin are derived by the present embodiment. Magnet reject blends up to 30 percent have been processed to 88 percent brightness. Processing 100 percent magnet rejects is impractical. Excessive chemical is required, making filtration and rinsing inefficient. Salt content not removed affects high viscosity and low brightness.

Improving kaolin brightness may affect viscosity as well. Low viscosity is important to efficient paper coating. Coating colors are commonly comprised of adhesive, additives, and primarily kaolin. They can be as high as 60 percent solids. The color is applied to a paper web surface and leveled with a trailing blade. The blade is a beveled metal plate situated to give best coating application. The paper web underneath the blade may move up to 4000 feet per minute. Without free-flow of coating colors or dilatancy, coating defects result. Dilatancy is viscosity thickening with increasing shear rate. Sometimes shear-thickening cause paper breaks.

Paper coating machines can be close to a city block long, and paper breaks can result in huge rooms filling with paper in seconds. Paper coaters strive for high solids coating colors to enhance coated paper properties. High solids reduce drying costs as well. But high solids make the coating color sensitive to excessive viscosity increase. During coating, colors gradually dewater to increased solids. This aggravates dilatancy and coating defects. Low viscosity kaolin is far less sensitive to coating defects.

Minor organic content of kaolin can have major effects on viscosity and brightness. Kaolin usually contains small amounts of organic derived from land surface vegetation. Soluble organic products are carried by groundwater and deposited on subsurface kaolin deposits. Analyses show as much as 0.066 percent organic on kaolin dry weight. After processing, organic can be as low as 0.008 percent and lower. The fundamental discoloration of kaolin, iron is complexed or chelated by organic acids. High molecular weight organics can be insoluble and difficult to remove. Iron associated with such organic becomes equally obstinate to removal. In colloidal suspension, organics greatly increase surface area and viscosity.

An additional viscosity culprit, the clay mineral montmorillonite occurs in variable but small amounts in many kaolins. Much smaller in particle size than kaolins, montmorillonite absorbs large amounts of water. High surface area and water absorption of montmorillonite can incur major viscosity increases. Extremely small particle size of colloidal organic and montmorillonite exert significant electro-viscous effects. Thus dilatancy and coating defects can result.

Kaolin in the present embodiment is dispersed with minimal dispersant, 0.05% Calgon, sodium hexametaphosphate. Adjust slurry to pH 8.5 with sodium hydroxide or sodium carbonate. Age slurry at least one hour to aid organic dispersion. With added titanium minerals, add 0.2 percent sodium sulfate decahydrate. Before adding, dissolve sodium sulfate decahydrate at 20 percent. Adjust kaolin slurry to pH 7 to 8 with 10 percent sulfuric acid. Heat slurry to 65 to 70 degrees centigrade for the preferred time of 30 minutes. Maintain pH range. After cooling to at least 40 degrees centigrade, bleach with sodium hydrosulfite. Preferred bleaching pH is 3 to 3.5. Continue natural cooling of slurry while bleaching. The preferred filtration pH is 2.5 to 3.

Sodium hydrosulfite level is 2 to 6 pounds per ton of dry kaolin. Optimum level is pre-determined. Reduction potential is maintained, measured instrumentally or colorimetrically. Gray coloration without hint of red, brown or yellow is preferred.

Bleaching is for 20 minutes where less than 0.4 percent ferric iron as Fe₂O₃ is present. Longer bleach times can be useful where abundant iron is complexed with organic. But 20 minutes is generally adequate. Filtering is at pH 2.5 to 3. Rinsing at a 2:1 ratio of water to dry weight of kaolin is preferred. If drying is employed, spray drying is preferable

Viscosity improvement occurs by the dispersion and extraction of organic materials during filtration and rinsing. Organics adsorb on both titania and kaolin surfaces, preferentially on titania. Titania selectively adsorbs organic acids. This is the fundamental mechanism of flotation methods for extracting titania. Such adsorption forms organophyllic surfaces, thus becoming substantive to further organic adsorption.

Much of the adsorbed organic is complexed with ferric iron. This makes titania a major spoiler of kaolin brightness.

Kaolins without additional titania are processed to 90 percent brightness. Kaolin and natural titania blends are processed to brightnesses from 88 to 90 percent. By this, costly synthetic titania can be replaced for opacity in paper coatings.

Magnet rejects in the present embodiment have a titania content of some four to five percent. Remaining magnet rejects comprise high iron kaolin and copious amounts of organic-iron complex. Titania minerals derived from selective flocculation is the most favorable source. It has least iron-organic complex, most favorable for high brightness. Drying of titania rejects makes removal of organic more difficult. The preferred embodiment is to avoid drying until slurry processing is complete.

Ferric iron is a strong oxidizing agent. Antioxidants are essential to stabilize reduced systems against re-oxidation. Magnet reject blends entails substantial addition of ferric-organic complex. Without antioxidants, the reduced system oxidizes during filtration, rinsing and drying. Such antioxidants as citric, maleic, and fumaric acids are useful. Sodium sulfate is preferred. It acts to disperse and saponify organics during high temperature leaching. During bleaching, sodium sulfate is reduced to the sulfite, an effective antioxidant. Further, the sulfite form enhances iron reduction and solution. Where bleach pH is below 3, titania is solubilized, indicated by violet coloration. Brightness of such kaolins is generally near 90 percent. Viscosity becomes dilatant at 70 percent solids.

Amount of sodium sulfate used can be reduced to improve filtration rate. Sodium sulfate decahydrate at 0.05 percent improves brightness and viscosity of kaolins. At ferric oxide levels of 0.4 percent and higher 0.2 percent sodium sulfate decahydrate is preferred.

Aluminum insolubilizes organic acids, precluding its efficient removal during filtration. Alum, hydrated aluminum sulfate is often added to improve filtration rate. It should be avoided unless high viscosity is not a problem. Aluminum makes viscosity worse than the standard processed kaolin equivalent. At pH 7 to 8 aluminum is insoluble and is the preferred heat treatment pH. Preferred processing time for this step is 30 minutes. Heat time can be highly variable. Longer time favors brightness up to about 60 minutes. Shorter time favors viscosity, but 30 minutes usually gives near Newtonian viscosity.

Brightness and viscosity by this embodiment are interdependent with filtration rate. Some of the organics when taken into colloidal suspension act as dispersants. Excessive dispersant of any kind adversely affects filtration rate. Thus minimal Calgon is utilized. Without efficient filtration and rinsing, product quality can be unacceptable. Use of one hundred percent rejects requires abundant chemical. Excessive chemical precludes good filtration and rinsing, essential to both brightness and viscosity. Blends of 30 percent rejects with quality kaolin have been processed to relatively high brightness, 88 percent. Near Newtonian viscosity is achieved with processing of the titania, kaolin blends.

Primary purpose of this embodiment is to disperse organics and organic-iron complex for removal during filtration and rinsing. Ferric iron in dispersed organic colloid is more amenable to reduction by sodium hydrosulfite. With sufficient sodium, mass action leads to some replacement of iron in the organic complex. Such saponified organic is much more soluble and easily removed during filtration. Rinse water that raises the system pH above 5.1 results in iron oxidation. Lower brightness is the result.

Novelties of this process comprise: dispersion of kaolins with minimal dispersant, such as Calgon, about 0.05 percent. Either sodium carbonate or sodium hydroxide is used to adjust slurry to pH 8.5. This is a compromise for best organic dispersion without solubilizing some aluminum. The slurry is aged at least one hour. Before heating, 0.2 percent sodium sulfate decahydrate or the equivalent anhydrous form is added. Sodium sulfate is dissolved in water at about 20 percent before addition to the slurry. The slurry is heated to 65 to 70 degrees centigrade for a preferred 30 minutes. Bleach time is 20 minutes. Longer bleach time is beneficial where ferric oxide is 0.4 or higher weight percent on dry kaolin. Up to 12 hours can affect continued iron reduction and solution. Generally acceptable brightnesses are gained at a 20 minute bleach time. Efficient filtration is critical. Rinsing is preferred at a 2:1 weight ratio of water to dry kaolin. Filtration is at pH 2.5 to 3 for maximum removal of organic colloids.

Viscosity in this embodiment is designated re large differences shown below:

| | |
|---|---|
| Can only be handled practically at less than | <70 dilatant |
| 70 percent solids and is shear-thickening | |
| Dilatant or shear thickening at | 70-dilatant |
| 70 percent kaolin solids | |
| Relatively high viscosity but shear-thinning, | thixo-thick |
| 70 percent solids | |
| Moderate viscosity but shear thinning, | thixo-medium |
| 70 percent solids | |
| low viscosity, shear thinning, | thixo-thin |
| 70 percent solids | |
| Very low viscosity, remaining same | Newtonian |
| with increasing, shear rate, 70 percent solids | |

Because kaolin crudes vary in iron, organic content, and titania levels the preferred treatment levels vary as well. Small differences in these components can affect significant processing modification. To achieve consistent high brightness and low viscosity, there are three variables that can be changed to gain the best brightness and viscosity. The first is the amount of sodium sulfate used. Highest ferric iron levels require highest levels of sodium sulfate. Up to an hour of heating can produce best brightness but this varies in accord with molecular weight of organics. High molecular weights affect most difficult processing. Minimal heating times favor low viscosity. Long bleach times favor brightness for those kaolins having highest ferric oxide levels. Maximum removal of soluble salts favors high brightness and low viscosity.

### Example 1

With approximate standard processing disperse crude with 0.05 percent Calgon and 0.025 percent sodium carbonate. Classify to 90 percent less than 2 microns. Bleach with sodium hydrosulfite at 5 pounds per ton of dry kaolin. Pre-determine optimum bleach level with small samples. Filter and rinse with a 1:1 weight ratio of water to dry kaolin. Dry at 110 degrees centigrade. Process the magnet rejects in the same fashion, but bleach with 60 pounds per ton on dry sample weight for 20 minutes.

Disperse crude kaolin with 0.05% Calgon and 0.025 percent sodium carbonate. Classify to 90 percent less than 2 microns. Raise slurry to pH 8.5 with sodium hydroxide and age one hour. Divide slurry into two samples. To both samples add 0.05 percent sodium sulfate decahydrate on dry kaolin weight. Add as a 20 percent solution. One sample is Heat one sample for 10 minutes at 65 to 70 degrees centigrade. Heat the second sample for 30 minutes. Bleach with 3 pounds per ton dry kaolin weight at pH 3 to 3.5.

Prepare three slurries comprised of twenty percent magnet rejects and 80 percent kaolin. The kaolin is 90 percent less than 2 microns kaolin slurry described above. Adjust slurries to pH 8.5 with a 10 percent solution of sodium hydroxide and age one hour. Add a 20 percent solution of 0.2 percent sodium sulfate decahydrate on dry kaolin weight to the three slurries. Adjust slurries to pH 7 to 8 with a 10 percent solution of sulfuric acid. Heat slurries to 65 to 70 degrees centigrade. Hold for 30 minutes while maintaining slurry pH. Pre-determine optimum bleach levels with small samples. After cooling to 40 degrees centigrade, begin bleach with sodium hydrosulfite. To one blend add 0.5 percent alum as a 10 percent solution before bleach. Bleach with 4 pounds per ton of dry kaolin at pH 3 to 3.5. Bleach 20 minutes for two samples, one of which has 0.5 percent alum. Bleach the third sample 12 hours maintaining pH 3 to 3.5 and reduction potential. Filter and rinse each sample at 2:1 ratio of water to dry kaolin. Dry at 110 degrees centigrade.

| | | % Brightness | % Brightness | |
|---|---|---|---|---|
| | Unprocessed | Standard Process | New Process | |
| Samples | % Brightness | 90 < 2 microns | 90% < 2 microns | Viscosity |
| Magnet rejects | 68.1 | 69 | | |
| Crude kaolin | 84.03 | 87.8 | | thixo-thick |
| Crude kaolin | | | 90.1 | Newtonian |
| New process | | | | |
| Same sample heated 10 minutes | | | 88.5 | Newtonian |
| 80% kaolin, | | | 89 | Newtonian |
| 20% magnet rejects | | | | |
| Same blend with alum | | | 89.3 | <70 dilatant |
| 80% kaolin, | | | 90 | Newtonian |
| 20% magnet rejects, bleached 12 hours | | | | |

Brightnesses and viscosities of the present embodiment are in line with high quality product specifications. Note that use of alum during bleach causes dilatant viscosity at solids less than 70 percent. Aluminum in alum, hydrated aluminum sulfate insolubilizes organic acids. Re-dispersed for use in application, aluminum-organic colloid causes dilatancy. Minor brightness improvement is gained by standard processing of magnetic rejects, 68.1 to 69. Sodium hydrosulfite at sixty pounds per ton of dry kaolin was used for this negligible improvement. There is a disproportionate increase in brightness with blends over straight magnet rejects. There is notable reduction in bleach requirement as well. The new process shows major brightness improvement of magnet rejects, but only in blends. Up to 30 percent magnet rejects blended with kaolin have been processed to 88 percent brightness. The data clearly show that highest brightness is obtained with longest heating time. Low viscosity is gained with minimal heat time.

### Example 2

Process by standard procedure Georgia kaolin designated “bentonitic.” Process a second bentonitic sample by the present embodiment. Use 0.05 percent sodium sulfate described in the previous example. For a third sample, in lieu of sodium sulfate use 0.05 percent citric acid. Heat the latter two samples 30 minutes.

| Sample | Viscosity | % Brightness |
|---|---|---|
| “bentonitic” kaolin, standard process | <70 percent-dilatant | 87.5 |
| Bentonitic kaolin New process | thixo-thin to Newtonian | 90 |
| Bentonitic kaolin, citric acid | thixo-thin | 89.8 |

Dispersed bentonite or montmorillonite in small amounts, one or two percent, imparts unacceptable viscosity. Producing Newtonian flow and 90 percent brightness, the new process overcomes viscosity problems. Benefit is gained by both sodium sulfate and citric acid.

### Example 3

For kaolin blends with natural titania, brightnesses were interpolated between clays of measured brightness. They are preceded with the symbol ˜: Samples other than the first two were dispersed with .0.5 percent Calgon and 0.025 percent sodium carbonate.

Adjust slurries to pH 8.5 with sodium hydroxide and age one hour. Prepare 20 percent solutions of sodium sulfate decahydrate, 0.2 percent on dry kaolin weight and add to slurries. Adjust to pH 7 to 8 and heat slurries to 65 to 70 degrees centigrade for 30 minutes. Maintain pH. Bleach each sample at 4 pounds sodium hydrosulfite per dry ton of kaolin. Hold at pH 3 to 3.5 for 20 minutes. Divide the sample containing 30percent magnet rejects into two samples. Bleach one for 20 minutes and the other for 12 hours. Throughout the bleach cycle hold slurry to pH 3 to 3.5.

| Sample | % Brightness | Viscosity |
|---|---|---|
| Commercial high brightness | 90.8 | thixo-medium |
| No. 1 particle size, standard process | ~88 | thixo-heavy |
| No. 1 kaolin by new process | ~90.1 | Newtonian |
| No.1 plus 10% rejects | ~89.5 | ″ |
| No.1 plus 18% rejects | ~88.9 | ″ |
| No. 1 plus 26% rejects | ~89 | ″ |
| No. 1 plus 30% rejects | ~88 | ″ |
| No ! plus 30% rejects | ~89 | ″ |

Bleached 12 hours

Note that the brightness increased to 89 from 88 percent for the sample bleached 12 hours. High quality kaolins for paper coating have brightnesses in the range of some 87.5 to 91. Thus each of the kaolins processed by the present embodiment meet product specifications. This is true despite exceptionally low brightness of magnet rejects, 68.1 percent.

### Example 4

Kaolin-titania blends show opacity, brightness, and gloss improvement in lightweight publication coating, 5 pounds per ream. This means that 2000 square feet of paper surface is coated with 5 pounds of coating.

| % | % | % | % |
|---|---|---|---|
| TiO₂ | Opacity | Brightness | Gloss |
| 1.60 | 83.3 | 64.2 | 51 |
| 2.34 | 84 | 64.9 | 63 |

Opacity improvement of 0.7 percentage points with less than one percent increase in titania is highly significant. Brightness increase is notable. But gloss increase is outstanding. Such benefits accrue with or without blends with titania.

### General Utility of Process

Many kaolin deposits worldwide are unsatisfactory re brightness and viscosity. The new process would overcome many brightness and viscosity problems of these kaolins. New kaolin deposits have been commercialized in Brazil of higher quality than those in Georgia. The present embodiment indicates greatly improved kaolin quality can be realized.

High opacity coating grade clays would enable cost-reduction for papermakers. Synthetic titania is expensive. Using this new process could enable greater competition by the kaolin industry. Other applications could benefit as well: paper filling, paint films, and filling of plastics, and rubber.

Kaolins of exceptional opacifying quality could be used for less stringent brightness applications. For example, specialty papers having much lower brightness needs than required for publication paper coatings.

### Alternative Methods of Processing

Other methods for extracting organic materials and iron are possible. Volatilization of organic can be achieved by calcination to about 400 degrees centigrade. Then extraction of iron would be achieved by the new process excluding aging at pH 8.5 and slurry heating.

Ozonation could be used after dispersion of organic by dispersants at high pH and high temperature. Depending on response to oxidation, organic would be removed more efficiently during filtration and rinsing.

Use of the most effective organic solvents, especially after dispersion of organics is another way to affect improved brightness and viscosity of kaolins.

During heating organic rises to the slurry surface and forms a coherent film The film can be lifted out of the slurry. It contains good kaolin as well and needs to be differentiated. This could be done by using low solids slurries, some 5 to 15 percent. It would allow cleaner separation of organic and kaolin.

Dispersion of kaolins with increased amounts of Calgon is recommended in U.S. Pat. No. 5,128,027. They extract particles less than 0.2 microns in diameter by centrifugation. Extra dispersant makes efficient filtration and rinsing excessively difficult. The present embodiment enables high brightnesses at high percentage natural titania blends for enhanced coating opacity. I achieve my results with a notably different process, using minimal Calgon as opposed to the competing patent using extra Calgon. Using higher levels of dispersant makes the process unreliable with respect to efficient filtration and rinsing.

Opposed to Phelps, high temperature is used in addition to high pH for colloidal dispersion. He uses pH greater than 9 for organic dispersion. I use pH 7 to 8 for heating, precluding high pH aluminum solution. Heating in the presence of pH 7 to 8 and sodium sulfate enhances saponification of organic. This enables more efficient removal of organic complex. Use of centrifugation after this treatment is another potentially viable process. Centrifugation is common practice in industry. It is used to classify particle size and to define kaolins. Thus centrifugation for removal of mineral slimes is not unique.

### CONCLUSION

One clear embodiment of the process is brightness improvement of both kaolin and titanium minerals. Three advantages spin from brightness improvement: 1 allows addition of natural titania to kaolins, especially to enhance opacity in paper coatings; 2 improved brightness and gloss of paper coatings; 3 utilization of waste material otherwise discarded. This enables some cost containment

A second embodiment of the present process is that it affects viscosity improvement. Higher quality products can be made from kaolins. Perhaps the greatest benefit of viscosity improvement is that it allows the use of unacceptable crude kaolins. Large reserves of crude kaolins contain montmorillonite, which the process rectifies. This means greatly increasing reserves that can be used to produce paper quality products. Indeed, acceptable quality kaolin reserves are in short supply in Georgia, USA.

My specification contains many parts, but they should not be construed as limitations on the scope. They are examples of preferred embodiments illustrated by my claims.

1. A process for beneficiating kaolins and kaolin-natural titania blends to high brightness by removing iron oxides, organics, and organic-iron complexes comprising:
dispersing kaolin with minimal dispersant.
raising said dispersed slurry to pH 8.5.
adjusting slurry to in the range of pH 7 to 8 and heating slurry.
lowering temperature of said slurry to at least 40 degrees centigrade before bleaching to reduce ferric iron to the ferrous state and reducing sodium sulfate to sodium sulfite.
continuing bleaching of said slurry without further heating, allowing it to cool.
filtering and rinsing the kaolin to extract soluble salts, ferrous iron, and organics.
blending said kaolin slurry with high titania mineral-bearing rejects derived from high brightness processes for titania mineral extraction.
adding an antioxidant to said blends in addition to sodium hydrosulfite
adding antioxidants, such as citric, maleic, or fumaric acids to said blends having ferric oxide levels greater than 0.4%,
adding sodium sulfate to aid dispersion and saponification adding sodium sulfate to become the antioxidant, sodium sulfite affected by sodium hydrosulfite during bleaching

1. The process in claim 1 wherein the dispersed kaolin is allowed to age at least 1 hour.

2. The process in claim 1 wherein said dispersing agent is any organic or inorganic dispersing agent that disperses kaolin and its impurities, such as those selected from the group consisting of sodium polymetaphosphates, sodium silicates, sodium polyacrylates and dispersion aids such as sodium citrate.

3. The process in claim 1 wherein the dispersed kaolin is raised to pH 8.5 with any alkali metal, the preferred embodiment sodium hydroxide or sodium carbonate.

4. The process in claim 1 wherein said blends with kaolin can be at least as high as 30 percent titania-bearing-rejects.

5. The process in claim 1 wherein a 20 percent solution of sodium sulfate is added to the slurry just prior to heat treatment.

6. The process in claim 5 wherein a preferred level of 0.2 percent sodium sulfate decahydrate on dry kaolin weight is added to the slurry as a 20 percent solution.

7. The process in claim 6 wherein said sodium sulfate becomes the antioxidant sodium sulfite during bleaching.

8. The process in claim 1 wherein the solids level is high enough to provide acceptable flocculation and filtration, preferably in the range of 20 to 40 percent.

9. The process in claim 1 wherein said dispersing agent is minimal. The suggested level is 0.05 percent on kaolin dry weight.

10. The process in claim 1 wherein said slurry is heated to 65 to 70 degrees centigrade for different periods depending on time needed to balance required brightness with viscosity. The preferred time is 30 minutes.

11. The process in claim 10 wherein said slurry is heated to higher or lower temperatures to gain product brightness and viscosity of processed kaolin.

12. The process in claim 11 wherein the time of maintaining designated temperature can vary from 10 minutes to 1 hour.

13. The process in claim 1 where the optimum bleach level is pre-determined and can vary between 1 to 6 pounds sodium hydrosulfite per dry ton of kaolin.

14. The process in claim 1 wherein said slurry is bleached with sodium hydrosulfite for variable times, up to 12 hours wherein ferric oxide occurs in the kaolin exceeding 0.4 percent.

15. The process in claim 13 wherein said slurry is bleached preferably at pH 3 to 3.5

16. The process in claim 15 wherein said bleached slurry is filtered preferably at pH 2.5 to 3.

17. The process in claim 16 wherein rinsing of said filtered kaolin is preferably at 2 to 1 ratio of water to dry kaolin.
